(19) United States
(12) Patent Application Publication
(10) Pub. No.: US 2004/0040898 A1
(43) Pub. Date: Mar. 4, 2004

(54) Method and system for sorting manual mail

(76) Inventor: Ottmar K. Kechel, Arlington, TX (US)

Correspondence Address: PGM, Philip G. Meyers Law Office, Suite 302, 1009 Long Prairie Road, Flower Mound, TX, 75022, US

(21) Appl. No.: 10/233,301

(22) Filed: Aug. 30, 2002

(51) Int. Cl. B07C 5/00; G06K 9/00; B07C 7/04

(52) U.S. Cl. 209/584; 209/900

(57) ABSTRACT

A process is provided for sorting mail pieces, especially manual mail, received at a postal processing and distribution center having associated mail delivery zones with associated postal delivery codes such as zip codes. Each delivery zone has one or more associated postal carriers which deliver mail to destination points within that zone. The delivery codes identify which zone and which carrier within the zone the mail piece should be delivered to. The process includes the steps of (a) receiving at a center mail for sorting; (b) sorting received mail that is addressed to delivery points in zones associated with that center to at least carrier level using a postal sorting machine having a number of pockets that receive sorted mail, resulting in sorted mail for zones associated with that center organized into batches by zone and by carrier; (c) sorting out received mail that is addressed to delivery points in zones not associated with that center for delivery to other centers; and (d) forwarding the sorted mail from step (b) to respective postal delivery units at which each carrier included in the sort of step (b) receives mail for delivery. Such a process eliminates at least one manual sorting step from current USPS processes for handling manual mail.

### TECHNICAL FIELD

The present invention relates to methods of mail sorting, especially sorting of manual mail of the types received by the U.S. Postal Service (USPS).

### BACKGROUND OF THE INVENTION

The USPS uses well known sorting machines to sort standard size letter mail. However, the postal service also receives a large volume of so-called “manual mail” which cannot be sorted by formerly available sorting machines because the size, thickness, or flexibility of such mail pieces renders them unsuitable for automated sorting. The USPS has for the most part handled such mail in a series a manual sorting operations, first sorting them into groups at sectional center facility (SCF) level (by the first 3 zip code digits) and, in the same manual sorting step, all mail destined for that center into the corresponding zone (5 digit zip code level). The mail sorted to 3-digit level is then sorted to zone (5 digit zip code level), then sorted to carrier level (by 9-digit zip code) and then, in a process referred to as manual casing, to delivery point level wherein each mail piece is grouped with other mail pieces to be delivered to the same delivery point or postal address. These manual sorting steps are highly labor intense and costly.

More recently, a USPS sorting machine known as an MLOCR-bulky, a multiline optical character reader sorting machine adapted for handling bulky mail, has been used to sort some types of manual mail that conform to the machine's capabilities. At the USPS's processing and distribution centers (P&DC'S), the MLOCR-bulky machine is used to sort a random collection of manual mail to the three-digit SCF level. Mail having the three-digit codes for which that center receives mail is retained, and mail for other codes is shipped out to other corresponding P&DC's. The retained mail is then combined with incoming mail from other P&DC's for the codes associated with that P&DC. The combined manual mail, all having the same first 3 zip code digits, is then sorted a second time to the 5-digit level (zone level.) Once the second automated sort is complete, the batches of 5-digit mail are shipped out to the associated local post offices at which they are sorted by postal workers to carrier level using up to 9 digits. The postal carriers themselves then sort the mail for their route in the final sort, using slotted sorting cases. The resulting process uses at maximum two automated sorts and three manual sorts, and thus still represents an enormous cost in labor to the USPS.

The USPS will soon commence use of DIOSS-EC machines (delivery bar code sorter input/output subsystem sorting machines with extended-capability) to handle certain types of manual mail. DIOSS-EC machines have a larger number of pockets (190) than typical MLOCR-bulky machines (only 64 pockets). It is estimated that as much as a large percentage of mail that is presently handled as manual mail could be sorted using the new DIOSS-EC machines or other machines with the same capabilities. The present invention provides an improved method of sorting what is now considered manual mail that can eliminate the third, manual sort in the known process and replace it with an automated sort, resulting in enormous savings in labor costs to the USPS.

### SUMMARY OF THE INVENTION

The present invention provides a process of sorting mail pieces, especially manual mail, received at a postal processing and distribution center having associated mail delivery zones with associated postal delivery codes such as zip codes. Each delivery zone has one or more associated postal carriers that deliver mail to destination points within that zone. The delivery codes identify which zone and which carrier within the zone the mail piece should be delivered to. The process includes the steps of:

(a) receiving at a center mail for sorting;

(b) sorting received mail that is addressed to delivery points in zones associated with that center to at least carrier level using a postal sorting machine having a number of pockets that receive sorted mail, resulting in sorted mail for zones associated with that center organized into batches by zone and by carrier;

(c) sorting out received mail that is addressed to delivery points in zones not associated with that center for delivery to other centers; and

(d) forwarding the sorted mail from step (b) to respective postal delivery units at which each carrier included in the sort of step (b) receives mail for delivery.

The process is preferably carried out concurrently at multiple (or all) processing and distribution centers of the postal system. As such, the mail received in step (a) will include mail from a geographic area associated with that center, and also mail from step (c) sent from one or more other centers. In step (c), received mail that is addressed to delivery points in zones not associated with that center is preferably sorted by zone.

Step (b) is preferably a two pass sort using a two pass sort scheme such that the number of pockets sorted to on the first pass times the number of pockets sorted to on the second pass is greater than or equal to the total number of carriers associated with that center. A minority of the total available machine pockets are used by the two-pass sort scheme on the first pass, and a majority of pockets in the first pass are used to concurrently carry out step (c), as explained further hereafter. In a preferred two pass sort scheme, in the first pass, mail for the zones associated with that center is sorted based on carrier groups defined by the maximum number of different carriers that each pocket will receive mail for during the second pass.

According to another aspect of the invention, divider cards are placed between mail for each carrier during the second pass. The divider cards can be fed into and sorted by the sorting machine using either coded labels to direct each card to the appropriate pocket, or by providing the sorter with software to remember which pockets to sort the cards to at the end of each batch, each batch corresponding to one pocket from the first pass sort.

The invention is primarily applicable to so-called “manual mail” which for purposes of the invention is flat mail which has one or more physical characteristics different from the majority of mail pieces other than parcels received for postal delivery, in particular, mail that has at least one physical characteristic that renders it unsuited for sorting on machines adapted to automatically sort letter mail. The physical characteristic is generally one or more of height, width, thickness or flexibility. These and other aspects of the invention are further discussed in the detailed description that follows.

### BRIEF DESCRIPTION OF THE DRAWING

In the accompanying drawing, wherein like numerals represent the same or similar elements throughout:

FIG. 1 is a schematic diagram of a DIOSS-EC machine set up for a first sorting pass according to the invention;

FIG. 2 is a schematic diagram of a DIOSS-EC machine set up for a second sorting pass according to the invention; and

FIG. 3 is a schematic diagram of a pocket at the end of the second pass sort, wherein the manual mail has been sorted by carrier and by group.

### DETAILED DESCRIPTION

The present invention takes advantage of the larger number of pockets or bins offered by the DIOSS-EC machine and sorts manual mail according to a different scheme than that currently used by the USPS with MLOCR-bulky machines. Multi-pass sort schemes based on significant digits of the zip code are well known for use in 2- and 3-pass sort schemes carried out by delivery bar code sorter (DBCS) machines, which sort letter mail down to carrier route order. According to the present invention, a sort scheme is designed given the total number of carriers for the P&DC in which the sort is to be carried out. For example, the Fort Myers P&DC receives mail for two 3-digit zip codes (339, 341) that have among them 56 associated 5-digit zip code zones. Each zone has a number of assigned carriers ranging from as few as 2 to as many as 48. The carrier assigned can be determined from the 5th and 6th zip code digits in the zip +4 code. The total number of carriers for the P&DC is 1,205.

A two-pass sort scheme is designed by assigning carriers into groups that correspond to the number of pockets that will be used on the first pass. In general, for such a two-pass sort scheme, the multiplication product of the number of pockets used on the first pass (P1) and the number of pockets used on the second pass (P2) must be greater than or equal to the total number of carriers C, (P1*P2>=C) since the goal is to sort to carrier level in two passes. In this example, given a machine with 180 total pockets available to receive mail on the second pass, only 8 pockets were used to receive mail for the Fort Myers P&DC on the first pass. The mail for the first carrier in each of the 56 zones went to the first pocket, the mail for the second carrier in each of the 56 zones went to the second pocket, and so on up to the eighth carrier for each zone. Then the sequence wrapped around and the mail for the ninth carrier for each zone went to the first pocket, the mail for the tenth carrier for each zone when to the second, and so on. As a result, the second pocket received the mail for the carriers 2, 10, 18, 24 and so on for each zone, up to the maximum number of carriers. The remaining pockets in the first pass were used for mail to be sent to other P&DC's based on 3-digit zip codes. The number of mail pieces going to each pocket was much greater than the pocket capacity, so each of the eight pockets were manually emptied (swept) during the sort as needed, with the operator taking care to keep the mail for each pocket together.

In the second pass, mail is fed from pocket 1 of the first pass and sorted, followed by mail from pockets 2 to 8, in that order. In the second pass, a larger number of pockets are used so that mail for each carrier of each zone (such as 1, 9, 17, 25 in the first pass pocket) is fed to a different pocket in the second pass. The mail from the first pocket of the first pass is thereby sorted by carrier and becomes the lowest numbered carrier in that slot. A sample organization of slots for the second pass would be:

| Pocket # | Zone | Carriers |
|---|---|---|
| 1 | 1 | 1 to 8 |
| 2 | 1 | 9 to 16 |
| 3 | 1 | 17 to last (23) |
| 4 | 2 | 1 to 8 |
| 5 | 2 | 9 to 16 |
| 6 | 2 | 17 to last (24) |
| 7 . . . | | |

and so on for the third and subsequent zone. Thus, for the mail from the first pocket, first sorting pass, a mail piece identified as zone 1, carrier 1 goes to pocket 1, a mail piece identified as zone 2, carrier 9 goes to pocket 5, a mail piece identified as zone 2, carrier 1 goes to pocket 4, and so on.

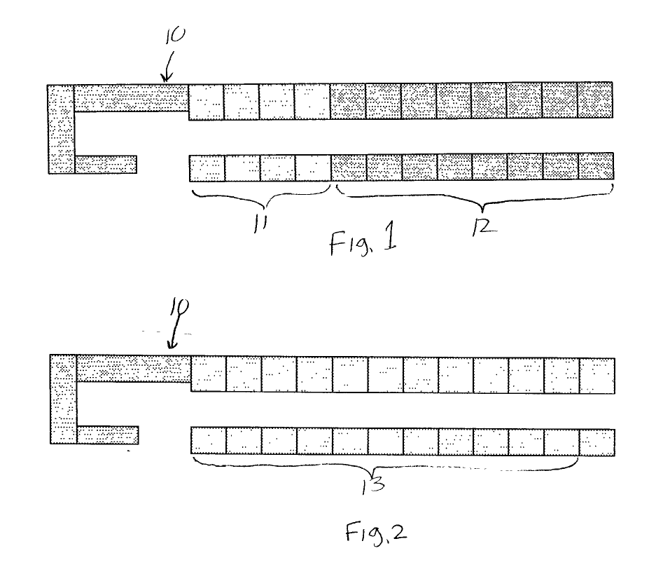

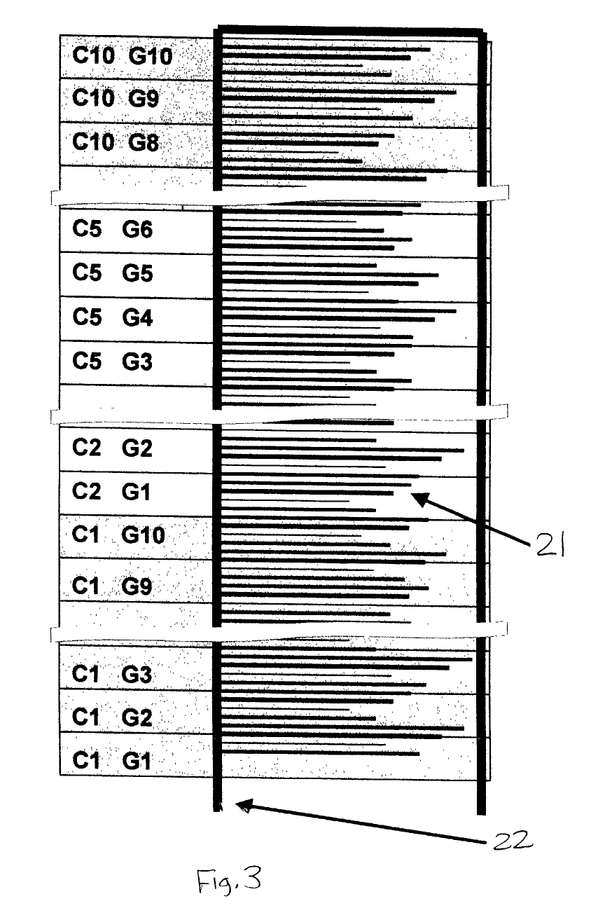

The DIOSS-EC machine will make it possible to more evenly balance the number of pockets used in the first and second passes, and also to sort to a level finer than carrier level by the end of the second pass. As shown in FIG. 1, in the first pass, a first group (11) of 32 pockets of the DIOSS-EC machine (10) are assigned for mail to be carrier sorted, and a second group (12) of 120 pockets are assigned for outgoing mail, with a few pockets left over to handle rejects of various kinds. In the second pass, FIG. 2, a group (13) of as many as 180 pockets are available. The product 32* 180=5,760 is much greater than the typical number of carriers associated with a given P&DC, e.g. 1,000. This permits sorting to a finer level, such as carrier group, within each carrier's mail. The result of this finer sort is shown in FIG. 3 at the end of the second pass. Mail pieces (21) are consecutively sorted into a pocket (22) for ten carriers C1-C10. Carrier 1 mail for a given zone is not only grouped together, it is also subdivided into ten carrier delivery groups based again on significant digits of the zip +4 (9 digit) code.

It is preferred according to the invention to use separator cards between the mail for successive carriers in each pocket in the second pass. Thus, according to the invention, after each “batch” corresponding to one pocket from the first sorting pass is completed, separator cards are placed behind each group of mail in the sorting pockets. This may be done manually but it is preferred to use the sorter to place the cards. For this purpose the cards can be labeled in the same manner as the mail pieces by zone and carrier so that they will be sorted in the same manner to the appropriate pocket. Optionally, the computer controlling the sorter can retain in memory which pockets received mail on the batch just completed, and sort generic, unlabeled cards one to each slot. This allows all of the cards to be the same and allows the machine rather than the operator to determine how many cards are needed. Thus, the operator may place a stack of cards on the loading area of the sorter and the pickoff mechanism of the sorter takes as many as it needs and leaves the rest. The operator then removes the excess cards and loads the next batch of mail, which will be sorted behind the cards just placed.

After mail pieces from all first sorting pass pockets have been sorted, sorting is complete down to the carrier level with divider cards making it easy for the postal worker to determine where one carrier's mail ends and another's begins. This effectively eliminates the third sort to carrier level, presently done manually at local post offices, described above. The mail is then shipped to the appropriate local post offices that receive mail from that center where it may be sorted (cased) by the carriers directly. The cards may be removed and re-used at any appropriate juncture.

In practice, it is preferred that the process of the invention be performed through twice per night at each P&DC. It has been projected that the first run, first and second passes can be performed from noon to 6 PM, and the second run, first and second passes be performed from 6 PM to 4:30 am, with batches of mail to other P&DC's being sent out at 3 PM and midnight. The incoming mail used at the start of the first pass sort from other P&DC's may be mail sorted at that other P&DC on a previous day that was shipped by truck or plane. However, it is possible that mail sent out from a sorting P&DC at 3 PM could arrive at its destination P&DC by midnight and thus be included in the second run for that P&DC, reducing mail delivery time.

The process of the invention as described above can be carried out on existing postal equipment capable of sorting manual mail. It has been estimated that USPS manual mail sorting to carrier time of nearly 29 million hours could be reduced by as much as one third using the process of the invention and DIOSS-EC machines. The would account for a large portion, 50% or more, of all manual mail. As more advanced sorting machines become available, the process of the invention can be applied to larger and larger quantities of manual mail.

The foregoing examples illustrate but do not limit the invention, which could for example be carried out for other types of mail or with machines other than DIOSS-EC, as long as a sufficient number of pockets are provided to cover the number of carriers. These and other modifications are within the scope of the claims that follow.

1. A process of sorting mail pieces received at a postal processing and distribution center having associated mail delivery zones with associated postal delivery codes, wherein each delivery zone has one or more associated postal carriers which deliver mail to destination points within that zone, and wherein the delivery codes identify which zone and which carrier within the zone the mail piece should be directed to, comprising the steps of:
(a) receiving at a center mail for sorting;
(b) sorting received mail that is addressed to delivery points in zones associated with that center to carrier level using a postal sorting machine having a number of pockets that receive sorted mail, resulting in sorted mail for zones associated with that center organized into batches by zone and by carrier;
(c) sorting out received mail that is addressed to delivery points in zones not associated with that center for delivery to other centers;
(d) forwarding the sorted mail from step (b) to respective postal delivery units at which each carrier included in the sort of step (b) receives mail for delivery.

2. The process of claim 1, wherein the process is carried out concurrently at multiple centers, and the mail received in step (a) includes mail from a geographic area associated with that center, and also includes mail from step (c) sent from one or more other centers.

3. The process of claim 1, wherein step (c) further comprises sorting received mail that is addressed to delivery points in zones not associated with that center by zone.

4. The process of claim 1, wherein step (b) is a two pass sort using a two pass sort scheme such that the number of pockets sorted to on the first pass times the number of pockets sorted to on the second pass is greater than or equal to the total number of carriers associated with that center.

5. The process of claim 4, wherein a minority of pockets are used by the two-pass sort scheme on the first pass, and a majority of pockets in the first pass are used to concurrently carry out step (c).

6. The process of claim 5, wherein, in the first pass, mail for the zones associated with that center is sorted based on carrier groups defined by the maximum number of different carriers that each pocket will receive mail for during the second pass.

7. The process of claim 6, wherein divider cards are placed between mail for each carrier during the second pass.

8. The process of claim 7, wherein the divider cards are fed into and sorted by the sorting machine.

9. The process of claim 1, wherein the mail pieces comprise manual mail which has one or more physical characteristics different from a majority of mail pieces received for postal delivery.

10. The process of claim 9, wherein the manual mail has at least one physical characteristic that renders it unsuited for sorting on machines configured to automatically sort letter mail.

11. The process of claim 10, wherein the physical characteristic is one or more of height, width, thickness or flexibility.
